(19) United States
(12) Patent Application Publication
(10) Pub. No.: US 2013/0233115 A1
(43) Pub. Date: Sep. 12, 2013

(54) VEHICLE

(71) Applicant: FUJI JUKOGYO KABUSHIKI KAISHA, Tokyo (JP)

(72) Inventors: Noriyoshi MATSUO, Tokyo (JP); Isamu NAGASAWA, Tokyo (JP)

(73) Assignee: FUJI JUKOGYO KABUSHIKI KAISHA, Tokyo (JP)

(21) Appl. No.: 13/793,439

(22) Filed: Mar. 11, 2013

(30) Foreign Application Priority Data
Mar. 12, 2012 (JP) 2012-053974

(51) Int. Cl. B62D 1/04

(52) U.S. Cl. CPC B62D 1/046
USPC 74/484 R

(57) ABSTRACT

There is provided a vehicle including a peripheral steering wheel, a grip forming a part of the wheel and being held by a user, and input units formed inside the wheel. Each input unit includes a first input switch to be actuated by a pressing action of a user's thumb, a second input switch to be actuated by a pressing action of the user's thumb, and a third input switch provided between the first input switch and the second input switch to be actuated by a sliding action of the user's thumb on the third input switch on the wheel while the user is holding the grip. The input by the first input switch allows a cyclic change to be performed for changing drive modes.

### CROSS REFERENCES TO RELATED APPLICATIONS

The present application claims priority from Japanese Patent Application No. 2012-053974 filed on Mar. 12, 2012, the entire contents of which are hereby incorporated by reference.

### BACKGROUND OF THE INVENTION

1. Field of the Invention

The present invention relates to a vehicle having a steering wheel provided with input units.

2. Description of the Related Art

Recently, steering wheels of vehicles have been provided with various kinds of buttons for setting various operations including a traveling mode setting, a car navigation setting, an audio playback and stop setting, an audio sound level setting, an air conditioner setting, and the like.

For example, Japanese Unexamined Patent Application Publication (JP-A) No. 2003-175783 has disclosed a vehicle-mounted device operation system in which an operation unit is provided on spokes of a steering wheel. It is possible for a driver to carry out blind operation by displaying the driver's selected operation near the driver's line of sight when driving.

In JP-A No. 2007-153181, a ring-like steering wheel is provided with a palm-rest unit with which the palm of a driver's hand is in contact and is provided with an operation unit with which vehicle-mounted devices can be operated while the driver's palm is in contact with the palm-rest unit.

JP-A No. 2009-161025 has disclosed a construction in which a protrusion is provided on an upper part of a spoke of a steering wheel and a switch is provided on the protrusion in order to allow operation of the switch provided on the steering wheel without gripping the switch.

However, the construction disclosed in the above Japanese Unexamined Patent Application Publications cannot realize a safe and sufficiently satisfactory operation in consideration of a driver's response to acceleration. In particular, it is preferable in a sports car to allow a driver to carry out the operation of the switch while holding the steering wheel and without the driver having to move ones hand off the steering wheel.

### SUMMARY OF THE INVENTION

In view of the above problems, the present invention aims to provide a vehicle having a steering wheel with which safe operation and sufficiently satisfactory operation can be performed in view of a response during acceleration of the vehicle.

An aspect of the present invention provides a vehicle including: a peripheral rim; a grip forming a part of the peripheral rim and being held by a user (driver); and input units formed inside the peripheral rim. Each of the input units includes a first input switch to be actuated by a pressing action of a user's thumb, a second input switch to be actuated by a pressing action of the user's thumb, and a third input switch provided between the first input switch and the second input switch to be actuated by a sliding action of the user's thumb on the third input switch while the user is holding the grip. The input by the first input switch allows a cyclic change to be performed for changing drive modes.

Preferably, the input by the third input switch changes a setting in a desired drive mode.

Preferably, the input by the third input switch changes a speed setting in the desired drive mode.

Preferably, the input by the third input switch changes a setting of a constant distance between a user's vehicle and a preceding vehicle that moves in front of the user's vehicle when the user's vehicle follows the preceding vehicle while maintaining the constant distance between the vehicles in the desired drive mode.

Preferably, each of the input units further includes a fourth input switch. The fourth input switch is located at any position except a position where the user's thumb can move smoothly when the user is holding the grip. The desired drive mode is released by the fourth input switch.

### BRIEF DESCRIPTION OF THE DRAWINGS

FIG. 1 is a plan view of a steering wheel of a vehicle according to an embodiment of the present invention;

FIG. 2 is a plan view of the steering wheel of the vehicle according to an embodiment of the present invention, illustrating a state in which a driver (user) is holding the steering wheel of the vehicle according to an embodiment of the present invention;

FIG. 3 is an enlarged sectional view of a part of the steering wheel of the vehicle according to a first embodiment of the present invention;

FIG. 4 is an enlarged sectional view of a part of the steering wheel of the vehicle according to a second embodiment of the present invention;

FIG. 5 is an enlarged sectional view of a first input switch of the steering wheel of the vehicle according to an embodiment of the present invention;

FIG. 6 is an enlarged sectional view of a fourth input switch of the steering wheel of the vehicle according to an embodiment of the present invention;

FIG. 7 is an enlarged view of a head of the fourth input switch of the steering wheel of the vehicle according to an embodiment of the present invention;

FIG. 8A to FIG. 8C are plan views illustrating a state in which a driver (user) is using the steering wheel of the vehicle according to an embodiment of the present invention;

FIG. 9 is an enlarged plan view of an input unit of the steering wheel of the vehicle according to an embodiment of the present invention, illustrating a state in which a driver (user) is using the unit; and

FIG. 10 is a plan view of a display of the vehicle according to an embodiment of the present invention.

### DESCRIPTION OF THE PREFERRED EMBODIMENTS

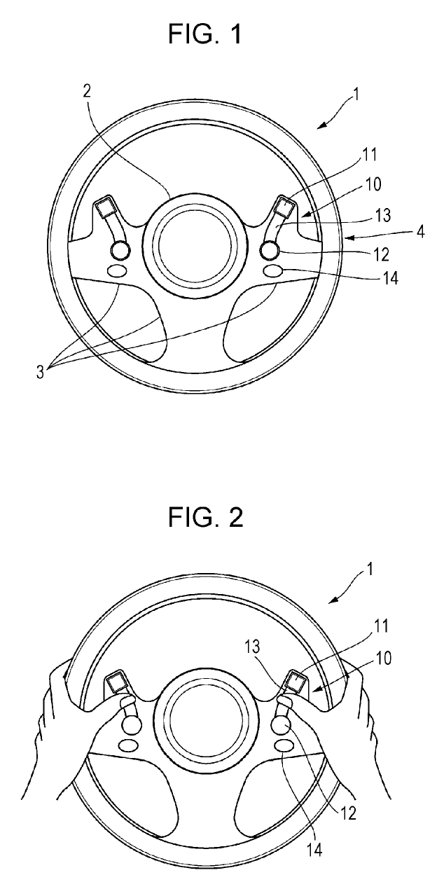

FIGS. 1 and 2 show an embodiment of a steering wheel of a vehicle of the present invention. The basic embodiment of the present invention will be described below with reference to FIGS. 1 and 2.

FIG. 1 is a plan view of a steering wheel 1 of a vehicle according to an embodiment of the present invention. The steering wheel 1 includes a peripheral rim, a central hub 2 containing an air bag therein, and spokes 3.

The steering wheel 1 has the spokes 3 that extend from the hub 2 to the rim in the right and left directions and in the downward direction. An input unit 10 is provided on each of the right and left spokes 3. Each input unit 10 is located on a corresponding one of the spokes 3 at a position at which a thumb of a driver (user) can move naturally to apply an input to the input unit 10 when the user is holding a grip 4 of the rim of the steering wheel 1.

Each input unit 10 includes a first input switch 11, a second input switch 12, a third input switch 13, and a fourth input switch 14. The first, second, and fourth input switches 11, 12, and 14 are formed as buttons.

FIG. 2 is a plan view of the steering wheel 1 of the vehicle according to an embodiment of the present invention, illustrating a state in which the user is holding the wheel 1.

The first input switch 11 is located on the spoke 3 at a position at which the user's thumb can be placed without applying any force, when the user is holding the grip 4 of the rim of the steering wheel 1. In addition, the side of the first input switch 11 that is nearer the third input switch 13 projects further forward (toward the user) than the flat surface of the third input switch 13.

The second input switch 12 is located on the spoke 3 at a position at which the user's thumb can be placed without having to change the positions of the four other fingers on the grip 4, when the user is holding the grip 4 of the rim of the steering wheel 1. Also, the side of the second input switch 12 at the other end of the third input switch 13 projects further forward (toward the user) than the flat surface of the third input switch 13.

The first input switch 11 has a quadrangular shape. The second input switch 12 has a circular shape. The fourth input switch 14 has an oval shape. Thus, the user can easily operate the input units 10 intuitively without having to look at them.

The third input switch 13 is disposed between the first input switch 11 and the second input switch 12 on the spoke 3 and is a slide-type switch having a flat surface. This slide-type switch (third input switch 13) may use an electrostatic capacitance system, an infrared radiation system, a surface elastic wave system, an electrical resistance membrane system, or an electromagnetic induction system. In the present invention, the electrostatic capacity system that is low in error is adopted.

The third input switch 13 determines a level of input by detecting a movement of the user's thumb on the flat surface of the switch 13.

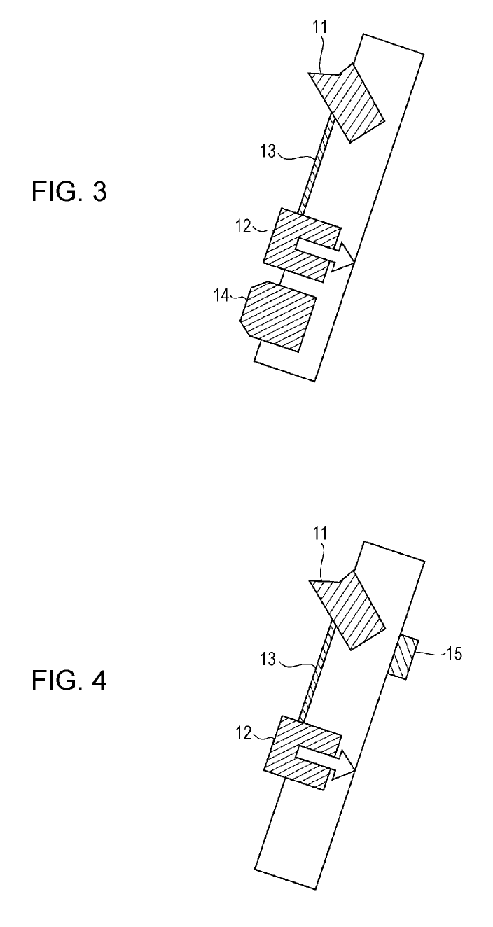

FIG. 3 is an enlarged sectional view of a part of the steering wheel 1 of the vehicle according to a first embodiment of the present invention. The first input switch 11 projects diagonally forward (toward the user) with respect to the flat surface of the third input switch 13 at an obtuse angle with respect to the flat surface. The second input switch 12 projects at a right angle with respect to the flat surface of the third switch input 13. The fourth input switch 14 projects at a right angle with respect to the flat surface of the third switch input 13, as in the case of the second input switch 12.

The side of the first input switch 11 that is nearer the third input switch 13 projects further than the other side of the switch 11 at the upper side of the steering wheel 1 from the user's point of view. Thus, it is possible to prevent the user from pressing the first input switch 11 accidentally instead of the third switch 13 when the user operates the steering wheel 1.

The second input switch 12 is disposed perpendicularly to the flat surface of the third input switch 13. The second input switch 12 is actuated by the user's thumb pushing the second input switch 12 downward in a direction perpendicular to the flat surface of the third input switch 13.

The fourth input switch 14 is located on the spoke 3 at any position except a position where the user's thumb can move smoothly on the spoke 3 when the user is holding the grip 4. This location will make operation of the switch difficult to some degree. However, it is possible to use the fourth input switch 14 as an important button in view of safety when the user is holding the steering wheel 1, since the user must be careful when pressing the fourth input switch 14.

FIG. 4 is an enlarged sectional view of a part of the steering wheel 1 of the vehicle according to a second embodiment of the present invention. The first input switch 11, the second input switch 12, and the third input switch 13 on the steering wheel 1 in the second embodiment of the vehicle are respectively disposed at the same positions as the first input switch 11, the second input switch 12, and the third input switch 13 on the steering wheel 1 in the first embodiment of the vehicle. In the steering wheel 1 in the second embodiment of the vehicle, a fifth input switch 15 is provided instead of the fourth input switch 14 on the steering wheel 1 in the first embodiment of the vehicle.

The fifth input switch 15 is located on the spoke 3 at a position where the user's forefinger can operate the switch 15 when the user is holding the grip 4. The fifth input switch 15 has the same function as the fourth input switch 14.

According to the above arrangement, it is possible to prevent the user from pressing the fifth input switch 15 accidentally, since the user cannot press the fifth input switch 15 unknowingly when only moving the user's thumb. The user must make a conscious effort to move their forefinger and must press the fifth input switch 15 in order to press the fifth input switch 15, thereby enhancing safety for important operations.

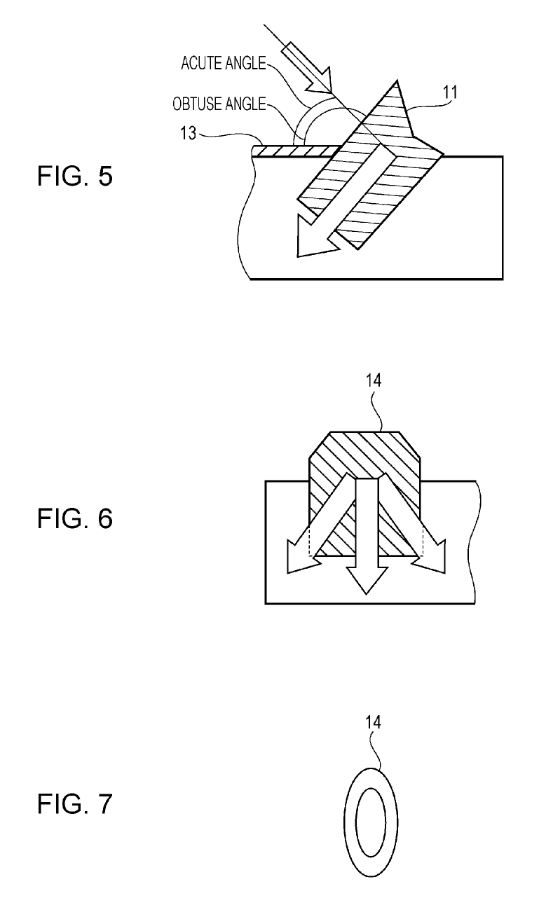

FIG. 5 is an enlarged sectional view of the first input switch 11 of the steering wheel 1 of the vehicle according to an embodiment of the present invention. The first input switch 11 projects frontward (toward the user) at an obtuse angle with respect to the flat surface of the third input switch 13. The first input switch 11 is pressed downward in a direction at an obtuse angle relative to the flat surface of the third input switch 13. Thus, even if the user attempts to press the first input switch 11 in a direction at an acute angle relative to the flat surface of the third input switch 13, the first input switch 11 cannot be operated.

FIG. 6 is an enlarged sectional view of the fourth input switch 14 of the steering wheel 1 of the vehicle according to an embodiment of the present invention. The fourth input switch 14 projects at a right angle relative to the flat surface of the third input switch 13.

FIG. 7 is an enlarged view of a head of the fourth input switch 14 of the steering wheel 1 of the vehicle according to an embodiment of the present invention. The head of the fourth input switch 14 is chamfered diagonally so as to be easily urged from any direction (see arrows in FIG. 6). Thus, the user can readily press the fourth input switch 14 continuously.

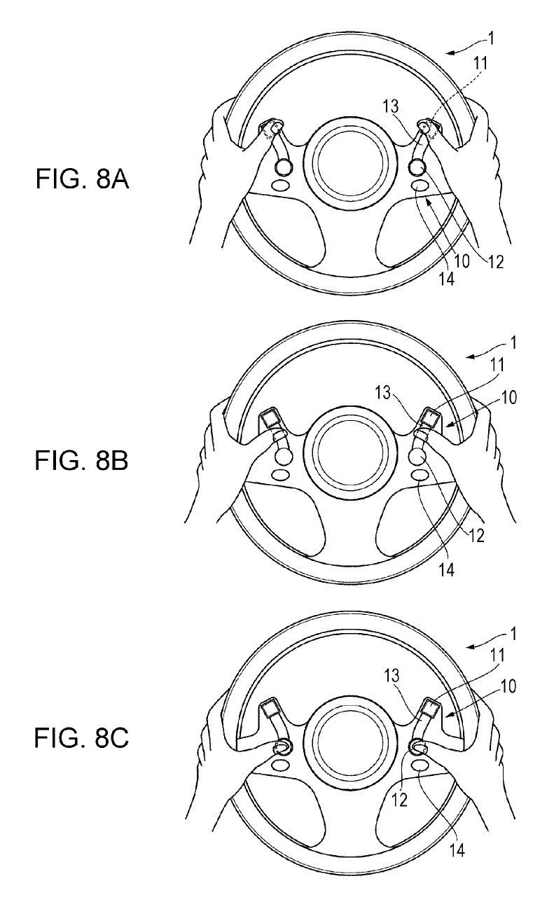

FIG. 8A to FIG. 8C are plan views illustrating a state in which the user is using the steering wheel 1 of the vehicle according to an embodiment of the present invention. FIG. 8A shows a state in which the user has their thumb on the first input switch 11. FIG. 8B shows a state in which the user has their thumb on the third input switch 13. FIG. 8C shows a state in which the user has their thumb on the second input switch 12.

In the case where the user has their thumb on the second input switch 12, the position of the thumb corresponds to a lower end position where the thumb can be placed without having to change the position of the user's four fingers located on the grip 4 of the steering wheel 1 when the user is holding the grip 4. Consequently, in order for the user to press down on the fourth input switch 14, the user must forcibly move the thumb onto the fourth input switch 14 in the case where the user is holding the grip 4 of the steering wheel 1.

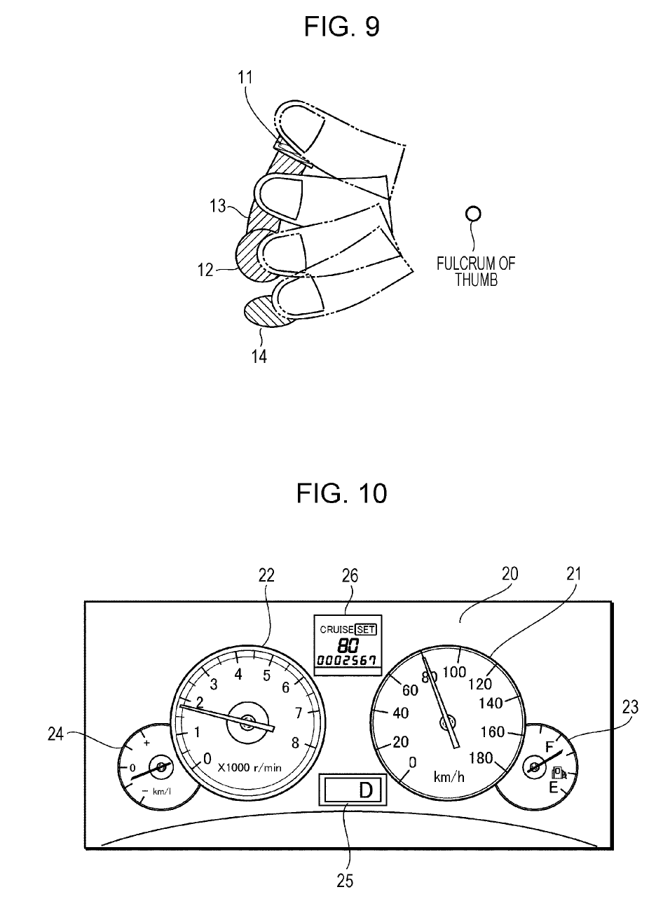

FIG. 9 is an enlarged plan view of an input unit 10 of the steering wheel 1 of the vehicle according to an embodiment of the present invention, illustrating a state in which a user is using the unit 10. Using the fulcrum of the thumb as a reference, the positional relationship among the input switches 11, 12, 13, and 14 in the vehicle of the present invention will be described below.

The first input switch 11 is located with respect to the fulcrum of the user's thumb at a position to which the thumb can move upward naturally and easily within a comfortable area when the user is holding the grip 4 of the steering wheel 1.

The second input switch 12 is located with respect to the fulcrum of the user's thumb at a position to which the thumb can move downward naturally and easily within a comfortable area when the user is holding the grip 4 of the steering wheel 1.

The third input switch 13 is located with respect to the fulcrum of the user's thumb at a position to which the user's thumb can move upward and downward naturally, and easily within a comfortable area when the user is holding the grip 4 of the steering wheel 1. The third input switch 13 is disposed between the lower side of the first input switch 11 and the upper side of the second input switch 12.

The fourth input switch 14 is located with respect to the fulcrum of the thumb at a position to which the user's thumb can move downward with slight effort when the user is holding the grip 4 of the steering wheel 1. For example, the fourth input switch 14 is disposed below the second input switch 12 and is spaced apart from the switch 12 by a thumb width.

The first, second, third, and fourth input switches 11, 12, 13, and 14 are located on an arcuate line that indicates the movement path of the thumb. In particular, the third input switch 13 is oriented along the arcuately curved line along the movement path of the thumb.

FIG. 10 shows a display board of the vehicle in an embodiment according to the present invention. Next, referring now to a display board 20 in FIG. 10, a specific operation of the input units 10 in an embodiment of the present invention will be described.

The display board 20 physically or electrically displays a speed meter 21, an engine tachometer 22, a fuel meter 23, a fuel economy gage 24, a shift position indicator 25, and a driving indicator 26. The speed meter 21 indicates a speed in an analogue manner while the engine tachometer 22 indicates an engine speed in an analogue manner.

The fuel meter 23 indicates the amount of fuel remaining in a fuel tank of a vehicle. The fuel economy gage 24 shifts its needle toward a plus side or a minus side on the basis of the average amount of fuel calculated by a traveling history of a user. The shift position indicator 25 indicates a current shift position selected by a user through a shift-operation.

The driving indicator 26 indicates a vehicle speed, a traveling distance, a drive mode, and the like.

There are in the embodiment three drive modes that are associated with a combination of an output characteristic of an engine and a control pattern of a transmission. For example, there are a fuel economy emphasis mode A, a traveling mode B that takes into consideration fuel economy and an accelerator response, and an accelerator response emphasis mode C.

These modes realize a performance that complies with user's demands by means of a plurality of output performances and control patterns set in an engine control unit (ECU) and a transmission control unit (TCU) for an automatic vehicle. For example, in the case where a user can comfortably drive a vehicle in an urban area or for long distance traveling, a smooth and practical output characteristic is set by the mode A, thereby realizing excellent fuel economy.

Also, in the embodiment, an advanced driver assistance system (ADAS) is installed in a vehicle. ADAS can control an automatic braking operation in response to detection of a collision, a speed control operation that is executed on the basis of the speed of a preceding vehicle, and a control operation that controls a distance between a preceding vehicle and a trailing vehicle. When an obstacle that may cause a collision is detected in front of a vehicle, an automatic braking operation is systematically performed. It is possible to realize a driver assistance mode, that is, a drive mode for following the preceding vehicle while maintaining a constant distance between the vehicles by ADAS and it is possible to set a speed and to control the distance between the vehicles.

In connection with the vehicle having the above drive modes (the modes A, B, and C, and the driver assistance mode), functions of the input units 10 of the steering wheel 1 in an embodiment of the present invention will be described below.

The first input switch 11 serves as a button for changing the drive modes. An input by the first input switch 11 enables a drive mode to carry out a cyclic change. For example, it is possible to change the drive mode through the cyclic change from the mode A through the mode B, the mode C, and the driver assistance mode to the mode A.

The drive mode is selected by performing input with the second input switch 12. The mode is released by the fourth input switch 14 or the fifth input switch 15.

The selected mode is displayed on the driving display 26 in response to selection of the mode. When a vehicle following mode is selected and is set, the expression “CRUISE SET” is displayed on the driving display 26.

When a vehicle is running at 40 km/h upon selection of the user assistance mode, the vehicle speed at this time is set. The vehicle runs at a constant speed unless the user steps on the accelerator pedal or the brake pedal. At this time, the constant speed is changed, when the user's thumb slides on the third input switch 13, namely the slide switch. At this time, it is not necessary to apply an input to the second input switch 12 that has a function of confirming a selection.

When the user's thumb moves the slide switch, namely the third input switch 13 upward, the speed increases. When the user's thumb moves the slide switch downward, the speed decreases.

In the case where a preceding vehicle exists in front of a user's vehicle in which the user is selecting the driver assistance mode, the user's vehicle follows the preceding vehicle while maintaining a constant distance between the vehicles. At this time, the constant distance between the vehicles can be changed by moving the user's thumb on the third input switch 13, namely, the slide switch. At this time, it is not necessary to apply an input to the second input switch 12 that has a function of confirming a selection.

When the user's thumb moves the slide switch upward, the distance between the vehicles increases. When the user's thumb moves the slide switch downward, the distance between the vehicles decreases.

In the above example, only the third input switch 13, namely, the slide switch can change the vehicle speed or the distance between the vehicles. However, the vehicle speed and the distance between the vehicles may be changed by tapping the second input switch 12 continuously. For example, the vehicle speed may be increased by tapping the second input switch 12 continuously after selecting the user assistance mode.

An example of the function regarding the drive modes is described above. However, since input units 10 are provided on the right and left sides of the steering wheel 1, for example, the respective input switches of the left side input unit 10 can be used for functions other than the selection or the adjustment of the drive mode. For example, the first input switch 11 may be used as a selection button for a playback mode or a stop mode, and the second input switch 12 may be used to select one of a sound level mode and a playback mode. The third input switch 13 may be used to adjust a sound level in the sound level mode while the third input switch 13 may be used to adjust a fast-forwarding function or a reversing function in the playback mode. Similarly, the third input switch 13 may be used to skip music tracks in the music selection mode.

Also, control of an air-conditioner can be performed, as in the case of the above example. For instance, the first input switch 11 may be used as a selection button for setting an air capacity or a temperature, and the second input switch 12 may be used to select one of an air capacity mode and a temperature-setting mode. The third input switch 13 may be used to adjust the air capacity in the air capacity mode while the third input switch 13 may be used to adjust the temperature set in the temperature-setting mode.

Also, control of a car navigation system can be performed, as in the case of the above example. For instance, the first input switch 11 may be used as a setting button for specifying the destination, and the second input switch 12 may be used to select one of the destinations. The third input switch 13 may be used to adjust a magnification scale of a map when the map is being displayed.

It is possible to install the above functions in any one of the right side input unit 10 and the left side input unit 10 in the steering wheel 1 of the vehicle of the present invention. Another switch button (not shown) may be used to change the functions of the input units 10. For example, it is possible to change the function of the left side input unit 10 in the steering wheel 1 from a function of controlling the air conditioner to a function of controlling an audio system.

### Constructions and Advantages of Embodiments

The vehicle according to an embodiment of the present invention includes a peripheral steering wheel 1, a grip 4 forming a part of the wheel 1 and being held by a user (driver), and input units 10 formed inside the wheel 1. Each of the input unit 10 includes a first input switch 11 to be actuated by a pressing action of a user's thumb, a second input switch 12 to be actuated by a pressing action of the user's thumb, and a third input switch 13 provided between the first input switch 11 and the second input switch 12 to be actuated by a sliding action of the user's thumb on the third input switch on the wheel 1 while the user is holding the grip 4. The input by the first input switch 11 allows a cyclic change to be performed for changing drive modes.

The above structure can achieve safe operation and can obtain sufficiently satisfactory operation in view of a response during acceleration of the vehicle.

In the vehicle according to the embodiment of the present invention, the input by the third input switch 13 changes a setting in a desired drive mode.

The above structure can achieve more comfortable driving in view of a response during acceleration of the vehicle, since the third input switch 13 does not restrict the steering operation.

In the vehicle according to the embodiment of the present invention, the input by the third input switch 13 changes a speed setting in the desired drive mode.

In the vehicle according to an embodiment of the present invention, the input by the third input switch 13 changes a setting of a constant distance between a user's vehicle and a preceding vehicle that moves in front of the user's vehicle when the user's vehicle follows the preceding vehicle while maintaining the constant distance between the vehicles in the desired drive mode.

Through the above structure, the speed and the distance between vehicles can be set more intuitively.

In the vehicle according to an embodiment of the present invention, each of the input units 10 further includes a fourth input switch 14. The fourth input switch 14 is located at any position except a position where the user's thumb can move smoothly when the user is holding the grip 4. The desired drive mode is released by the fourth input switch 14.

The above structure can achieve safe operation.

What is claimed is:

1. A vehicle including:
a peripheral rim;
a grip forming a part of the peripheral rim and being held by a user; and
input units formed inside the peripheral rim;
each of the input units including:
a first input switch to be actuated by a pressing action of a user's thumb;
a second input switch to be actuated by a pressing action of the user's thumb; and
a third input switch provided between the first input switch and the second input switch to be actuated by a sliding action of the user's thumb on the third input switch while the user is holding the grip;
the input by the first input switch allows a cyclic change to be performed for changing drive modes.

2. The vehicle according to claim 1, wherein
the input by the third input switch changes a setting in a desired drive mode.

3. The vehicle according to claim 2, wherein
the input by the third input switch changes a speed setting in the desired drive mode.

4. The vehicle according to claim 2, wherein
the input by the third input switch changes a setting of a constant distance between a user's vehicle and a preceding vehicle that moves in front of the user's vehicle when the user's vehicle follows the preceding vehicle while maintaining the constant distance between the vehicles in the desired drive mode.

5. The vehicle according to any one of claim 2, wherein
each of the input units further includes a fourth input switch;
the fourth input switch is located at any position except a position where the user's thumb can move smoothly when the user is holding the grip; and
the desired drive mode is released by the fourth input switch.

6. The vehicle according to any one of claim 3, wherein
each of the input units further includes a fourth input switch;
the fourth input switch is located at any position except a position where the user's thumb can move smoothly when the user is holding the grip; and
the desired drive mode is released by the fourth input switch.

7. The vehicle according to any one of claim 4, wherein
each of the input units further includes a fourth input switch;
the fourth input switch is located at any position except a position where the user's thumb can move smoothly when the user is holding the grip; and
the desired drive mode is released by the fourth input switch.
